(19) United States
(12) Patent Application Publication
(10) Pub. No.: US 2008/0109970 A1
(43) Pub. Date: May 15, 2008

(54) Radio frequency identification based system and method for aligning one end of a passenger boarding bridge with a doorway of an aircraft

(75) Inventor: Neil Hutton, Ottawa (CA)

Correspondence Address: FREEDMAN & ASSOCIATES, 117 CENTREPOINTE DRIVE, SUITE 350, NEPEAN, ONTARIO, K2G 5X3, omitted

(73) Assignee: DEW Engineering and Development Limited, Ottawa (CA)

(21) Appl. No.: 11/594,880

(22) Filed: Nov. 9, 2006

(51) Int. Cl. B64F 1/305; G08B 1/08

(52) U.S. Cl. 14/71.5; 340/686.6

(57) ABSTRACT

A system for aligning an aircraft-engaging end of a passenger boarding bridge with a doorway of an aircraft includes a passive radio frequency identification (RFID) tag for being disposed at a known location aboard the aircraft, relative to the doorway thereof. The passive RFID tag includes a tag antenna and an integrated circuit for encoding data relating to the passive RFID tag. An antenna including a plurality of antenna elements is disposed proximate the aircraft-engaging end of the passenger boarding bridge. The antenna emits radio frequency waves and receives from the passive RFID tag a wireless data communication signal including the encoded data. A processor is provided for identifying the encoded data within the wireless data communication signal, for determining an angle of arrival of the encoded data based on differences in signal received at each of the plurality of antenna elements and for determining an intensity of the signal including the encoded data. A bridge controller in communication with the processor determines a movement of the passenger boarding bridge toward the doorway of the aircraft, based on the determined angle of arrival of the encoded data and the intensity of the signal including the encoded data.

### FIELD OF THE INVENTION

The instant invention relates to passenger boarding bridges, and more particularly to a system and method for aligning one end of a passenger boarding bridge with a doorway of an aircraft based on signals from radio frequency identification tags that are located aboard the aircraft.

### BACKGROUND

In order to make aircraft passengers comfortable, and in order to transport them between an airport terminal building and an aircraft in such a way that they are protected from the weather and from other environmental influences, passenger boarding bridges are used which are telescopically extensible and the height of which is adjustable. For instance, an apron drive bridge includes a plurality of adjustable modules, including: a rotunda, a telescopic tunnel, a bubble section, a cab, and elevating columns with wheel carriage. Other common types of passenger boarding bridges include radial drive bridges and over-the-wing (OTW) bridges. These types of passenger boarding bridges are adjustable, for instance to compensate for different sized aircraft and to compensate for imprecise parking of aircraft at an airport terminal.

A manual bridge alignment system requires that a human operator is present to perform the alignment operation each time an aircraft arrives. Delays occur when the human operator is not standing-by to perform the alignment operation as soon as the aircraft comes to a stop. In addition, human operators are prone to errors that result in the passenger boarding bridge being driven into the aircraft or into a piece of ground service equipment. Such collisions involving the passenger boarding bridge are costly and also result in delays. In order to avoid causing a collision, human operators tend to err on the side of caution and drive the passenger boarding bridge slowly and cautiously.

Semi-automated bridge alignment systems also require a human operator, but the human operator may be present at a remote location and interact with the bridge control system in a tele-robotic manner. One human operator may interact with a plurality of different passenger boarding bridges, thereby reducing the costs associated with training and paying the salaries of human operators. Alternatively, certain movements of the bridge are automated, whilst other movements are performed under the control of the human operator.

Automated bridge alignment systems provide a number of advantages compared to manual and semi-automated systems. For instance, automated bridge alignment systems do not require a human operator, and therefore the costs that are associated with training and paying the salaries of human operators are reduced or eliminated. Furthermore, an automated bridge alignment system is always standing by to control the passenger boarding bridge as soon as an aircraft comes to a stop. Accordingly, delays associated with dispatching a human operator to perform a bridge alignment operation are eliminated, particularly during periods of heavy aircraft traffic.

Early attempts at automated bridge alignment systems employed imagers and sensors disposed on or about the passenger boarding bridge, for sensing locations of aircraft doorways and for sensing close approach of the bridge to the aircraft. More recently, automated bridge alignment systems have been developed in which beacon docking signals and/or control signals are transmitted wirelessly between an aircraft and a passenger boarding bridge, as described for example in U.S. Pat. Nos. 6,637,063, 6,742,210, 6,757,927 and 6,907,635, the entire contents of all of which are incorporated herein by reference. Other systems relying upon wireless transmission of signals between an aircraft and a passenger boarding bridge during alignment are disclosed in U.S. patent applications Ser. Nos. 11/149,401, 11/155,502, 11/157,934 and 11/157,938, the entire contents of all of which are incorporated herein by reference.

In the above-mentioned automated bridge alignment systems a transmitter unit is disposed aboard the aircraft either when the aircraft is manufactured or as part of an after-market retrofit, either of which results in an initial high cost to install and program such transmitter units in each individual aircraft. Since there is a cost associated with installing the transmitter units in each aircraft, an airline operator may chose not to install transmitters in certain aircraft if those aircraft do not stop frequently at airports that are equipped with a compatible bridge alignment system. In addition, airline operators may not install transmitters for all doorways of an aircraft, resulting in some of the doorways being unavailable for use when automated bridge alignment is performed. Furthermore, the transmitter units are powered either by being wired into the aircraft electrical system or by being equipped with an internal power supply such as for instance a battery. When internal power supplies are used, periodic maintenance is required to replace the power supply.

Furthermore, the use of rf emitting devices is regulated in airport settings, and certain jurisdictions may prohibit entirely the use of transmitter units of the type that are described in the above-mentioned automated bridge alignment systems, due to concerns about causing interference with other aircraft systems or with ground operation systems. For this reason, it may be necessary to deactivate the transmitter unit upon arrival at certain destinations, and then subsequently reactivate the transmitter unit after departure therefrom. This creates a burden on the flight crew, or requires additional automated features associated with the transmitter units themselves.

### SUMMARY OF EMBODIMENTS OF THE INVENTION

In accordance with an aspect of the instant invention there is provided a system for aligning an aircraft-engaging end of a passenger boarding bridge with a doorway of an aircraft, comprising: a passive radio frequency identification (RFID) tag for being disposed at a known location aboard the aircraft relative to the doorway, the passive RFID tag comprising a tag antenna and an integrated circuit for encoding data relating to the passive RFID tag; an antenna for being disposed proximate the aircraft-engaging end of the passenger boarding bridge, for emitting radio frequency waves and for receiving from the passive RFID tag a wireless data communication signal including the encoded data; a processor for identifying the encoded data within the wireless data communication signal, for determining spatial information relating to a location of the passive RFID tag relative to the antenna and for determining an intensity of the signal including the encoded data; and, a bridge controller in communication with the processor for determining a movement of the passenger boarding bridge toward the doorway of the aircraft based on the determined spatial information and the intensity of the signal including the encoded data.

In accordance with another aspect of the instant invention there is provided a system for aligning an aircraft-engaging end of a passenger boarding bridge with a doorway of an aircraft, comprising: a first passive radio frequency identification (RFID) tag for being disposed at a known first location aboard the aircraft relative to the doorway, the first passive RFID tag comprising a first tag antenna and a first integrated circuit for encoding first data that is unique to the first passive RFID tag; a first directional RFID reader for being disposed proximate the aircraft-engaging end of the passenger boarding bridge, the first directional RFID reader comprising a plurality of first radio frequency (rf) antenna elements for conductively coupling with the first tag antenna so as to support exchange of first wireless communication signals therebetween, and a first processor for determining first directional information relating to the first passive RFID tag based on the exchanged first wireless communication signals; and, a bridge controller in communication with the first directional RFID reader for determining a movement of the passenger boarding bridge toward the doorway of the aircraft based on the determined first directional information.

In accordance with another aspect of the instant invention there is provided a method for aligning an aircraft-engaging end of a passenger boarding bridge with a doorway of an aircraft, the aircraft equipped with a passive radio frequency identification (RFID) tag that is disposed at a known location relative to the doorway, the method comprising: moving the aircraft-engaging end of the passenger boarding bridge to an interrogation position, the interrogation position based on an expected stopping location of the doorway of the aircraft; using a plurality of antenna elements disposed aboard the passenger boarding bridge, emitting a radio frequency (rf) interrogation signal for energizing the passive RFID tag; using the plurality of antenna elements disposed aboard the passenger boarding bridge, receiving a modulated form of the rf interrogation signal after reflection from the passive RFID tag; determining an angle of arrival of the modulated form of the rf interrogation signal based on differences in the signal received at each of the plurality of antenna elements; based on the determined angle of arrival, determining a movement of the passenger boarding bridge toward the doorway of the aircraft; and, automatically performing the determined movement of the passenger boarding bridge toward the doorway of the aircraft.

In accordance with another aspect of the instant invention there is provided a method for aligning an aircraft-engaging end of a passenger boarding bridge with a doorway of an aircraft, the aircraft equipped with a passive radio frequency identification (RFID) tag that is disposed at a known location relative to the doorway, the method comprising: using a directional RFID reader that is disposed proximate the aircraft-engaging end of the passenger boarding bridge, transmitting a radio frequency (rf) interrogation signal for energizing the passive RFID tag; receiving an rf signal at the directional RFID reader, the rf signal being a modulated form of the rf interrogation signal reflected from the passive RFID tag, wherein the modulation is indicative of data that is encoded uniquely within the passive RFID tag; determining angle of arrival data based on differences in the rf signal received at each antenna element of a plurality of antenna elements of the directional RFID reader; determining an intensity of the rf signal received at the directional RFID reader; based on the determined angle of arrival data and the determined intensity, determining a movement of the passenger boarding bridge for moving the aircraft-engaging end thereof toward the doorway of the aircraft; and, automatically performing the determined movement of the passenger boarding bridge toward the doorway of the aircraft.

In accordance with another aspect of the instant invention there is provided a system for aligning an aircraft-engaging end of a passenger boarding bridge with a doorway of an aircraft, comprising: a passive radio frequency identification (RFID) tag for being disposed at a known location aboard the aircraft relative to the doorway, the passive RFID tag comprising a tag antenna and an integrated circuit for encoding data that is unique to the passive RFID tag; a plurality of antenna elements for being disposed proximate the aircraft-engaging end of the passenger boarding bridge, for emitting radio frequency waves and for receiving from the passive RFID tag a wireless data communication signal including the encoded data; a processor for identifying the encoded data within the wireless data communication signal, for determining an angle of arrival of the encoded data based on differences in signal received at each of the plurality of antenna elements and for determining an intensity of the signal including the encoded data; and, a bridge controller in communication with the processor for determining a movement of the passenger boarding bridge toward the doorway of the aircraft based on the determined angle of arrival of the encoded data and the intensity of the signal including the encoded data.

In accordance with another aspect of the instant invention there is provided a method for aligning an aircraft-engaging end of a passenger boarding bridge with a doorway of an aircraft, the aircraft equipped with a passive radio frequency identification (RFID) tag, the method comprising: providing a visual docking guidance system (VDGS) in association with the passenger boarding bridge; identifying a type and sub-type of the aircraft; based on the identified type and sub-type of the aircraft, guiding the aircraft to a predetermined stopping position adjacent to the passenger boarding bridge; interrogating the passive RFID tag using a RFID reader that is disposed proximate the aircraft-engaging end of the passenger boarding bridge; receiving from the passive RFID tag a wireless data communication signal in response to the passive RFID tag being interrogated, the wireless data communication signal including data that is encoded by an integrated circuit of the passive RFID tag, the data including type and sub-type information for the aircraft; comparing the type and sub-type information for the aircraft as received from the passive RFID tag to the identified type and sub-type of the aircraft; and, when the comparison results in a match, automatically aligning the aircraft-engaging end of the passenger boarding bridge with the doorway of the aircraft.

### BRIEF DESCRIPTION OF THE DRAWINGS

Exemplary embodiments of the invention will now be described in conjunction with the following drawings, in which similar reference numbers designate similar items:

FIG. 1a is a simplified top view showing a system according to an embodiment of the instant invention in an interrogation mode of operation;

FIG. 1b is a simplified top view showing the system of FIG. 1a in a listening mode of operation;

FIG. 2a is a simplified top view showing a system according to an embodiment of the instant invention in an interrogation mode of operation;

FIG. 2b is a simplified top view showing the system of FIG. 2a in a listening mode of operation;

FIG. 3 illustrates a high level diagram of a directional RFID reader;

FIG. 4 illustrates in greater detail the directional RFID reader of FIG. 3;

FIG. 5 is a simplified flow diagram of a method according to an embodiment of the instant invention;

FIG. 6 is a simplified flow diagram of another method according to an embodiment of the instant invention; and,

FIG. 7 is a simplified flow diagram of another method according to an embodiment of the instant invention.

### DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

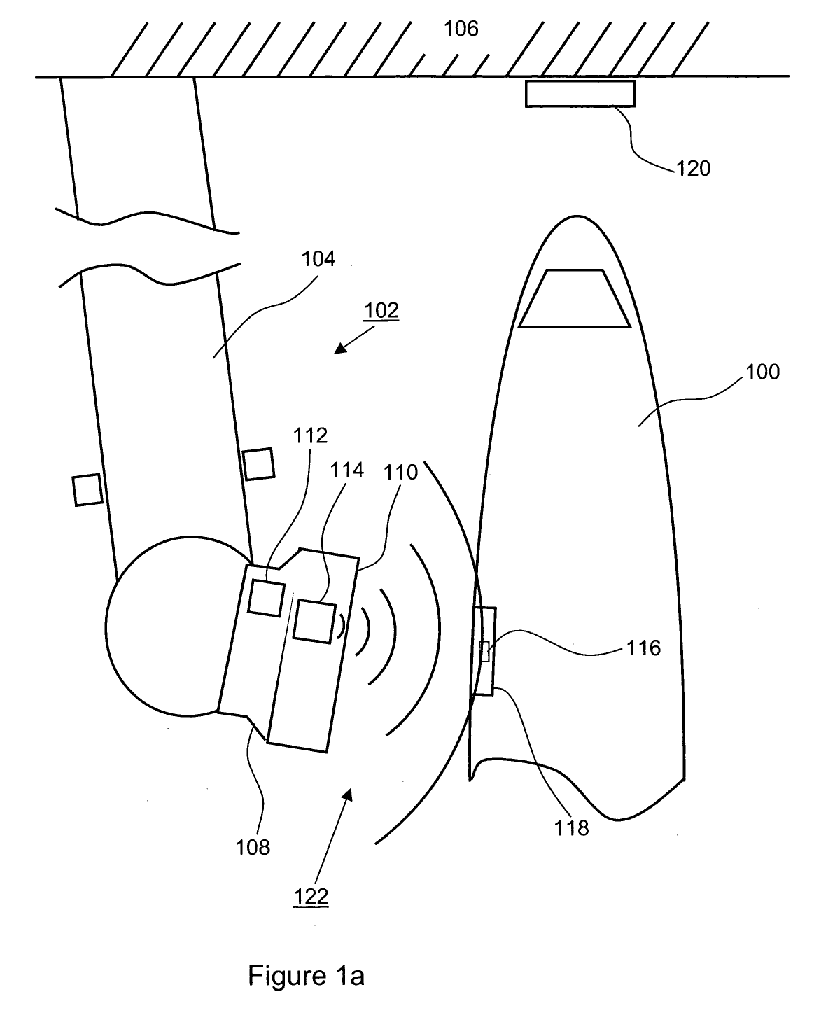

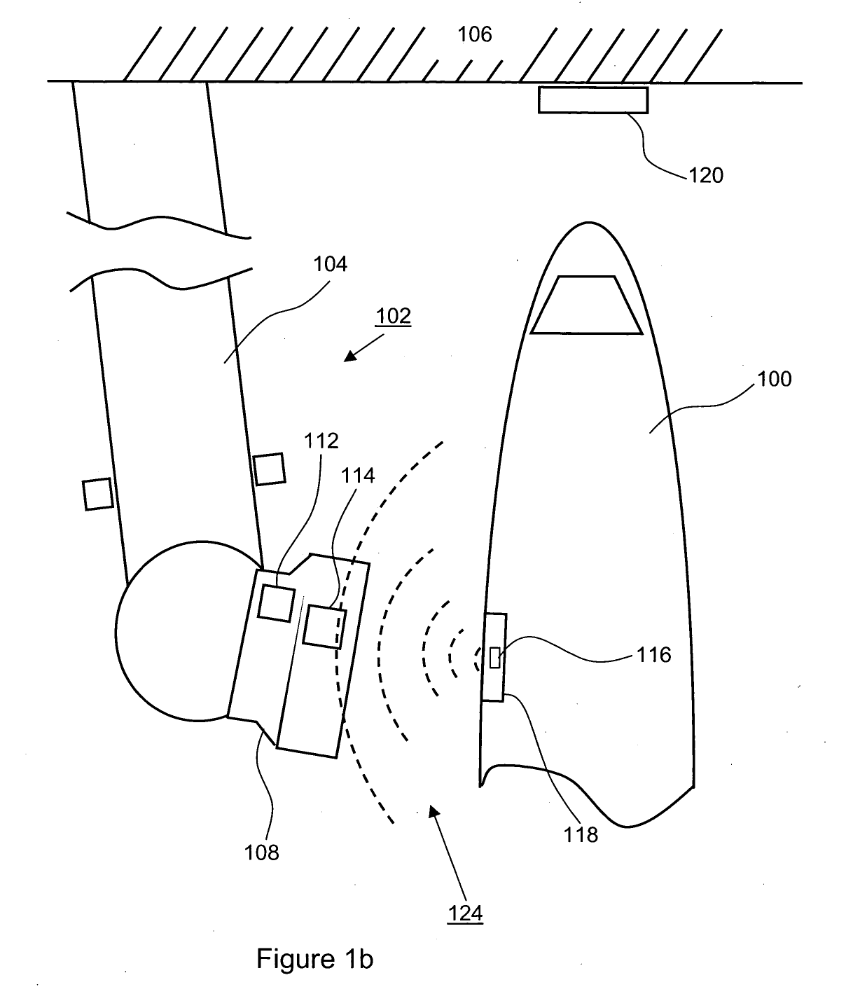

Referring to FIG. 1a, shown is a simplified top view of a system according to an embodiment of the instant invention in an interrogation mode of operation. An aircraft 100 is stopped at or proximate a stopping position within a parking space that is defined adjacent to passenger boarding bridge 102. The passenger boarding bridge 102 includes a passageway 104 extending between a terminal building 106 and a pivotal cabin 108. The cabin 108 is open at an aircraft-engaging end 110 thereof. A controller 112 of an automated bridge alignment system is provided within the cabin 108 of the passenger boarding bridge 102. Optionally, the controller 112 is disposed within another portion of the passenger boarding bridge 102, or within terminal building 106. The controller 112 is in communication with, and provides instruction signals to, not illustrated mechanisms of the automated bridge alignment system, which includes mechanisms for adjusting the length and the angular orientation of the passageway 104 relative to the terminal building 106, for tilting and pivoting the cabin 108 relative to the passageway 104, and for vertically displacing the cabin 108 relative to the ground surface etc. The controller 112 is also in communication with a directional RFID reader 114, which is disposed proximate the aircraft-engaging end 110 of passenger boarding bridge 102. The directional RFID reader 114 includes a plurality of antenna elements and a processor. For instance, the directional RFID reader 114 includes at least four radio frequency (rf) antennae. The directional RFID reader 114 is for exchanging wireless data communication signals with a passive RFID tag 116, which is disposed aboard aircraft 100 at a location that is known relative to doorway 118. In FIG. 1 a the directional RFID reader 114 is embodied in the form of a unit comprising the plurality of antenna elements and the processor, as well as transceiver elements for controlling the system's data acquisition and communication. Alternatively, the plurality of antenna elements is provided separately from, but in communication with, the transceiver elements and the processor. For instance, the antenna elements are distributed around the edge of the aircraft-engaging end 110 of the pivotal cabin 108.

Also shown in FIG. 1a is a visual docking guidance system (VDGS) 120, as is well known in the art, including a sensing portion for sensing approach of the aircraft 100 toward the stopping position, and a display portion for providing instructions in the form of symbols and/or alphanumeric characters, the instructions for use by the pilot while guiding the aircraft toward the stopping position. Of course, use of the VDGS 120 for guiding aircraft 100 to the stopping position is optional. Alternatively, a ground marshal or guide man guides the aircraft 100 to the stopping position in a known fashion.

Referring still to FIG. 1a, the passive RFID tag 116 includes a tag antenna and an integrated circuit for encoding data that is unique to the passive RFID tag 116. Alternatively the encoded data is not unique to the passive RFID tag 116. By way of a non-limiting example, the encoded data optionally is common to a group of passive RFID tags, such as for instance a group of RFID tags for being disposed aboard a particular type and sub-type of aircraft. Further optionally, all RFID tags have common data encoded therein. Passive RFID tag 116 is a radio frequency identification device that does not have any internal power source. The energy source for passive RFID tag 116 is the power that is emitted from the plurality of antenna elements disposed aboard the passenger boarding bridge 100. As shown diagrammatically in FIG. 1a, the directional RFID reader 114 powers the passive RFID tag 116 by emitting a radio frequency wave shown generally at 122.

Referring now to FIG. 1b, shown is a simplified top view of the system of FIG. 1a in a listening mode of operation. In particular, the passive RFID tag 116 encounters the magnetic field of the radio frequency wave 122 that was emitted by the reader, and the coiled antenna within the tag 116 is responsive to the magnetic field for thereby energizing the circuits in the passive RFID tag 116. Finally, the passive RFID tag 116 sends the information that is encoded in the integrated circuit thereof by modulating the energizing field and returning a signal 124 to the RFID reader 114.

The signal 124 is received at each of the plurality of antenna elements of the RFID reader 114. Based upon differences in the signal 124 that is received at the different antenna elements, angle of arrival and intensity data relating to the signal 124 may be determined. A wide variety of methods are available for computing the angle of arrival. For example, Ziskind and M. Wax, “Maximum Likelihood Localization of Multiple Sources by Alternating Projection,” IEEE Transactions on Acoustics, Speech, and Signal Processing, Vol. 36, NO. 10, October 1988 is considered to be suitable for this purpose. This method minimizes the computational requirement of the directional RFID reader 114. The tradeoff for minimized computational complexity is accuracy. It should be noted that a receiver will likely receive wireless signal that arrive at the receiver after bouncing off a surface that is not normally associated with wireless transmitter. Such reflected signals should correspond to a local maximum signal intensity but not a global maximum of signal intensity. When a local maximum is confused with a global maximum then an incorrect angle of arrival measurement is likely to be provided.

The angle of arrival and intensity data is provided to controller 112, and is used in the determination of an instruction for moving the passenger boarding bridge toward the doorway of the aircraft. The bridge is then moved according to the determined instruction, under the control of the controller 112. Optionally, directional RFID reader 114 continues to interrogate the passive RFID tag 116 during execution of the movement, determining updated angle of arrival and intensity data as the distance to the aircraft decreases, such that improved accuracy and reliability is achieved.

It should be noted that passive RFID tags are currently approved for use on aircraft, provided that certain criteria are satisfied. In particular, it is currently a requirement that the tags must operate in the “passive-only” mode. Currently, it is also required that the tags must not reflect back ambient RF energy of 35 decibels referenced to 1 microvolt per meter. This criterion must be satisfied to ensure that the tags do not pick up energy emitted by the engines or other devices, reflect it back and possibly interfere with aircraft systems. Furthermore, the frequency used by the tags must be outside the published aviation frequency bands to prevent interference with aircraft systems. The most common RFID frequencies—2.45 MHz, 915 MHz and 13.56 MHz-do not overlap with any frequencies used in aviation and are acceptable for use with the systems and methods according to the instant invention. Finally, passive tags must be interrogated only on the ground when the aircraft is not in operation, and must function properly when installed and be designed “to operate in an aircraft operational environment with robust radio frequency stability.” Accordingly, passive RFID tag 116 is selected in order to satisfy all of the above-mentioned criteria. That being said, changes to the above-mentioned criteria may occur in the future and necessitate selection of a passive RFID tag 116 having properties commensurate with the criteria that are determined at that time, or even allow selection of RFID tags having properties substantially different from those described in this document. For instance, in the future the selection of active RFID tags may be possible as well as economically viable.

In FIG. 1a and FIG. 1b, the passive RFID tag 116 is shown disposed at a location on the inside of the window of doorway 118. Optionally, the passive RFID tag 116 is disposed at some other location aboard the aircraft, provided that the location is known relative to the doorway 118. Due to the non-contact, non-line-of-sight nature of the technology, the primary requirement for effective tag placement aboard the aircraft 100 relates to the interrogation signal range for the particular directional RFID reader 114. In other words, the passive RFID tag 116 should be disposed aboard the aircraft 100 at a location that is within transmission range of directional RFID reader 114, when the passenger boarding bridge 102 is at the interrogation position. Generally speaking, the closer the passive RFID tag 116 is relative to the doorway 118 of aircraft 100, the lower the power requirement for providing the interrogation signal 122, and therefore the lower the chances of causing undesirable interference with aircraft or ground operation systems. Of course, the passive RFID tag 116 can be read through a variety of substances such as snow, fog, ice, paint, crusted grime, and other visually and environmentally challenging conditions, where optically read technologies would be useless. Passive RFID tag 116 can also be read in challenging circumstances at remarkable speeds, in most cases responding in less than 100 milliseconds. It is envisaged that low-frequency systems (30 KHz to 500 KHz), which have short reading ranges and lower system costs, may also be utilized in the embodiments of the instant invention.

It should also be noted that, in the specific and non-limiting example that is shown in FIGS. 1a and 1b, passive RFID tag 116 has encoded therein data that is entirely unique to that specific tag. Accordingly, when the passive RFID tag 116 is mounted at a location aboard aircraft 100, a record is created associating information relating to the specific aircraft 100 with the data encoded in the tag. For instance, the information relating to the specific aircraft 100 includes at least the type and sub-type of aircraft 100. Optionally, other information such as for instance the identity of the airline that operates aircraft 100 is included. When the passive RFID tag 116 is interrogated, the signal that is returned may be decoded to extract the unique data that is associated with the tag. The unique data may then be used to look up and retrieve the information relating to the specific aircraft 100 in a database. When the VDGS 120 is used during automated alignment, the type and sub-type as determined by (or provided to) the VDGS 120 may be confirmed, based upon the retrieved information relating to the specific aircraft 100.

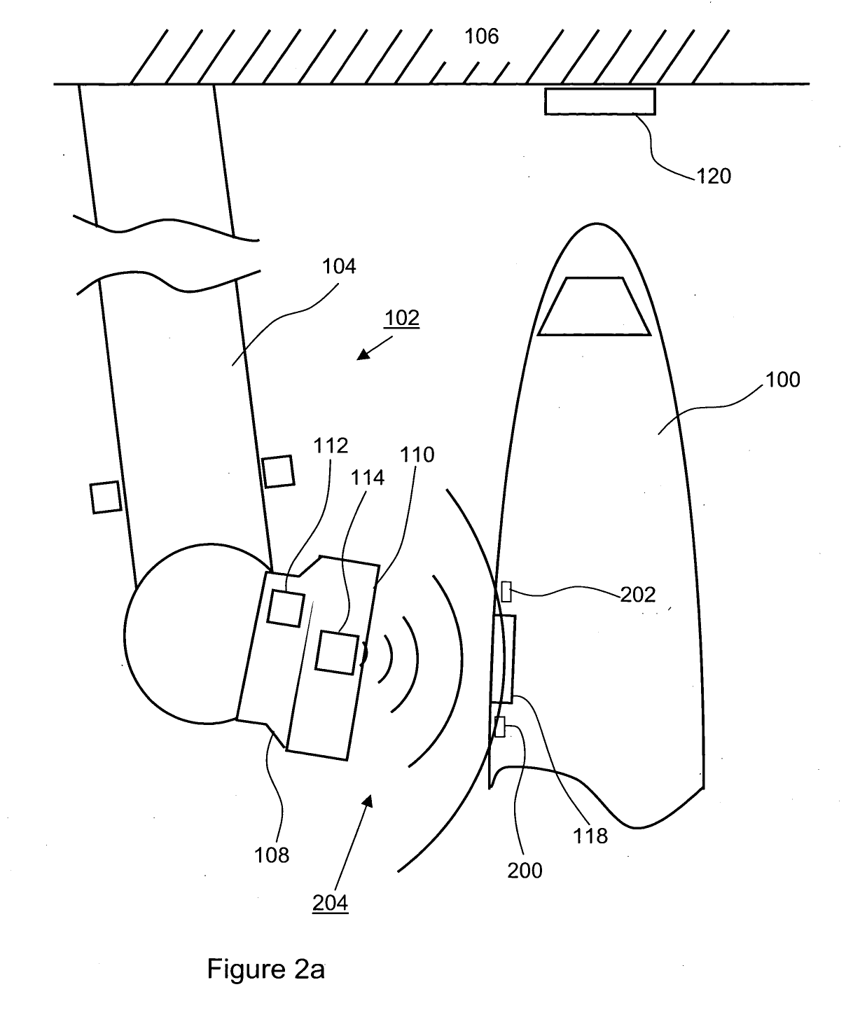

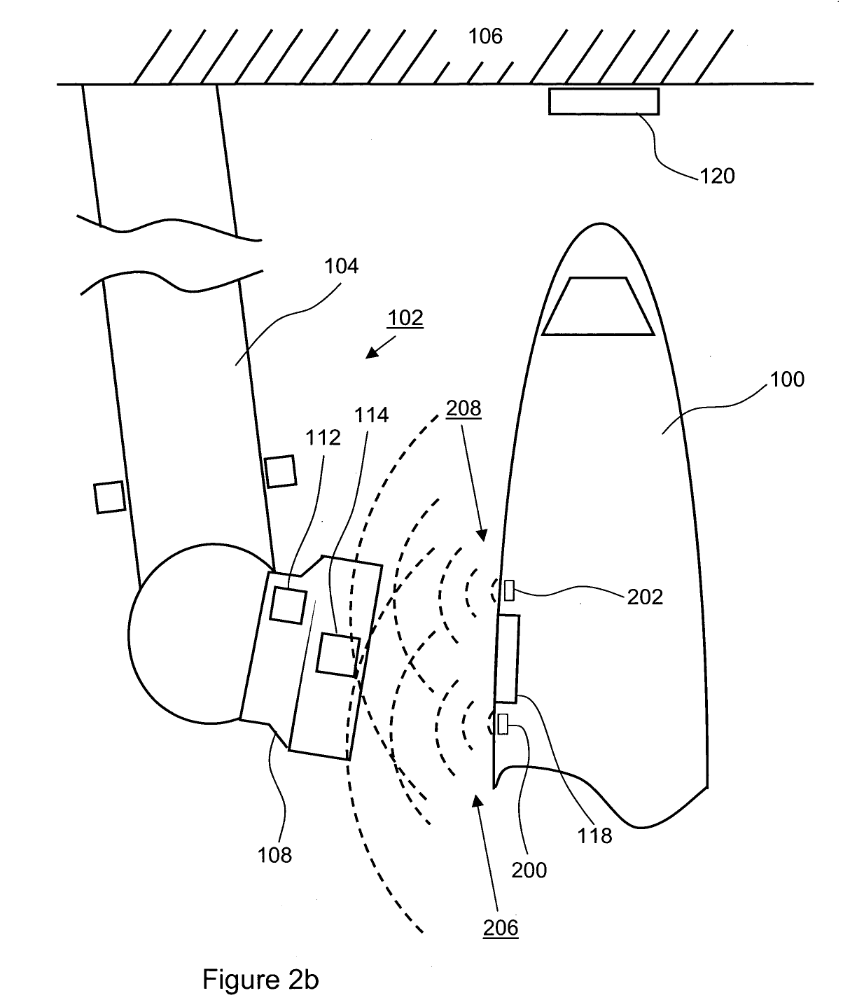

Referring now to FIG. 2a, shown is a simplified top view of a system according to an embodiment of the instant invention in an interrogation mode of operation. An aircraft 100 is stopped at or proximate a stopping position within a parking space that is defined adjacent to passenger boarding bridge 102. The passenger boarding bridge 102 includes a passageway 104 extending between a terminal building 106 and a pivotal cabin 108. The cabin 108 is open at an aircraft-engaging end 110 thereof. A controller 112 of an automated bridge alignment system is provided within the cabin 108 of the passenger boarding bridge 102. Optionally, the controller 112 is disposed within another portion of the passenger boarding bridge 102, or within terminal building 106. The controller 112 is in communication with, and provides instruction signals to, not illustrated mechanisms of the automated bridge alignment system, which includes mechanisms for adjusting the length and the angular orientation of the passageway 104 relative to the terminal building 106, for tilting and pivoting the cabin 108 relative to the passageway 104, and for vertically displacing the cabin 108 relative to the ground surface etc. The controller 112 is also in communication with a directional RFID reader 114, which is disposed proximate the aircraft-engaging end 110 of passenger boarding bridge 102. The directional RFID reader 114 includes a plurality of antenna elements and a processor. For instance, the directional RFID reader 114 includes at least four radio frequency (rf) antennae. The directional RFID reader 114 is for exchanging wireless data communication signals with a plurality of passive RFID tags including passive RFID tags 200, 202, which are disposed aboard aircraft 100 at locations that are known at least relative to doorway 118. In FIG. 2a the directional RFID reader 114 is embodied in the form of a unit comprising the plurality of antenna elements and the processor, as well as transceiver elements for controlling the system's data acquisition and communication. Alternatively, the plurality of antenna elements is provided separately from, but in communication with, the transceiver elements and the processor. For instance, the antenna elements are distributed around the edge of the aircraft-engaging end 110 of the pivotal cabin 108.

Also shown in FIG. 2a is a visual docking guidance system (VDGS) 120, as is well known in the art, including a sensing portion for sensing approach of the aircraft 100 toward the stopping position, and a display portion for providing instructions in the form of symbols and/or alphanumeric characters, the instructions for use by the pilot while guiding the aircraft toward the stopping position. Of course, use of the VDGS 120 for guiding aircraft 100 to the stopping position is optional. Alternatively, a ground marshal or guide man guides the aircraft 100 to the stopping position in a known fashion.

Referring still to FIG. 2a, each passive RFID tag 200, 202 of the plurality of passive RFID tags includes a tag antenna and an integrated circuit for encoding data that is unique to the passive RFID tag 200 or 202. Alternatively the encoded data is not unique to each of the passive RFID tags 200 or 202. By way of a non-limiting example, the encoded data optionally is common to a group of passive RFID tags, such as for instance a group including RFID tags 200 and 202 for being disposed aboard a particular aircraft. Further optionally, all RFID tags have common data encoded therein. Passive RFID tags 200 and 202 are radio frequency identification devices that do not have any internal power source. The energy source for passive RFID tags 200 and 202 is the power that is emitted from the plurality of antenna elements disposed aboard the passenger boarding bridge 100. As shown diagrammatically in FIG. 2a, the directional RFID reader 114 powers each of the passive RFID tags 200 and 202 by emitting a radio frequency wave shown generally at 204.

Referring now to FIG. 2b, shown is a simplified top view of the system of FIG. 2a in a listening mode of operation. In particular, the passive RFID tags 200 and 202 encounter the magnetic field of the radio frequency wave 204 that was emitted by the reader, and the coiled antenna within each tag 200 and 202 is responsive to the magnetic field for thereby energizing the circuits in each respective passive RFID tag. Finally, the passive RFID tag 200 sends the information that is encoded in the integrated circuit thereof by modulating the energizing field and returning a signal 206 to the RFID reader 114. Similarly, the passive RFID tag 202 sends the information that is encoded in the integrated circuit thereof by modulating the energizing field and returning a signal 208 to the RFID reader 114.

The signals 206 and 208 are received at each of the plurality of antenna elements of the RFID reader 114. Based upon differences in the signal 206 that is received at the different antenna elements, angle of arrival and intensity data relating to the signal 206 may be determined. Similarly, based upon differences in the signal 208 that is received at the different antenna elements, angle of arrival and intensity data relating to the signal 208 may be determined. A wide variety of methods are available for computing the angle of arrival. For example, Ziskind and M. Wax, “Maximum Likelihood Localization of Multiple Sources by Alternating Projection,” IEEE Transactions on Acoustics, Speech, and Signal Processing, Vol. 36, NO. 10, October 1988 is considered to be suitable for this purpose. This method minimizes the computational requirement of the directional RFID reader 114. The tradeoff for minimized computational complexity is accuracy. It should be noted that a receiver will likely receive wireless signal that arrive at the receiver after bouncing off a surface that is not normally associated with wireless transmitter. Such reflected signals should correspond to a local maximum signal intensity but not a global maximum of signal intensity. When a local maximum is confused with a global maximum then an incorrect angle of arrival measurement is likely to be provided.

The angle of arrival and intensity data is provided to controller 112, and is used in the determination of an instruction for moving the passenger boarding bridge toward the doorway of the aircraft. The bridge is then moved according to the determined instruction, under the control of the controller 112. Optionally, directional RFID reader 114 continues to interrogate the passive RFID tags 200 and 202 during execution of the movement, determining updated angle of arrival and intensity data as the distance to the aircraft decreases, such that improved accuracy and reliability is achieved.

As discussed supra it should be noted that passive RFID tags are currently approved for use on aircraft, provided that certain criteria are satisfied. In particular, the tags must operate in the “passive-only” mode. Currently, it is also required that the tags must not reflect back ambient RF energy of 35 decibels referenced to 1 microvolt per meter. This criterion must be satisfied to ensure that the tags do not pick up energy emitted by the engines or other devices, reflect it back and possibly interfere with aircraft systems. Furthermore, the frequency used by the tags must be outside the published aviation frequency bands to prevent interference with aircraft systems. The most common RFID frequencies—2.45 GHz, 915 MHz and 13.56 MHz—do not overlap with any frequencies used in aviation and are acceptable for use with the systems and methods according to the instant invention. Finally, passive tags must be interrogated only on the ground when the aircraft is not in operation, and must function properly when installed and be designed “to operate in an aircraft operational environment with robust radio frequency stability.” Accordingly, passive RFID tags 200 and 202 are selected in order to satisfy all of the above-mentioned criteria. That being said, changes to the above-mentioned criteria may occur in the future and necessitate selection of passive RFID tags 200 and 202 having properties commensurate with the criteria that are determined at that time.

In FIG. 2a and FIG. 2b, the passive RFID tags 200 and 202 are shown disposed at a location adjacent to the doorway 118. For instance, the tags 200 and 202 are affixed to the outer surface of the fuselage of the aircraft, or are affixed to the interior surface of windows adjacent to doorway 118, or they may even be affixed to an interior wall surface of the aircraft cabin. Optionally, the passive RFID tags 200 and 202 are disposed at some other locations aboard the aircraft, provided that the locations are known relative to the doorway 118. Due to the non-contact, non-line-of-sight nature of the technology, the primary requirement for effective tag placement aboard the aircraft 100 relates to the interrogation signal range for the particular directional RFID reader 114. In other words, the passive RFID tags 200 and 202 should be disposed aboard the aircraft 100 at locations that are within transmission range of directional RFID reader 114, when the passenger boarding bridge 102 is at the interrogation position. Generally speaking, the closer the passive RFID tags 200 and 202 are relative to the doorway 118 of aircraft 100, the lower the power requirement for providing the interrogation signal 204, and therefore the lower the chances of causing undesirable interference with aircraft or ground operation systems. Of course, the passive RFID tags 200 and 202 can be read through a variety of substances such as snow, fog, ice, paint, crusted grime, and other visually and environmentally challenging conditions, where optically read technologies would be useless. Passive RFID tags 200 and 202 can also be read in challenging circumstances at remarkable speeds, in most cases responding in less than 100 milliseconds. It is envisaged that low-frequency systems (30 KHz to 500 KHz), which have short reading ranges and lower system costs, may also be utilized in the embodiments of the instant invention.

It should also be noted that, in the specific and non-limiting example that is shown in FIGS. 2a and 2b, passive RFID tags 200 and 202 have encoded therein data that is entirely unique to each respective tag. Accordingly, when the passive RFID tags 200 and 202 are mounted aboard aircraft 100, a record is created associating information relating to the specific aircraft 100 with the data encoded in each tag. For instance, the information relating to the specific aircraft 100 includes at least the type and sub-type of aircraft 100. Optionally, other information such as for instance the identity of the airline that operates aircraft 100 is included. When the passive RFID tags 200 and 204 are interrogated, the signals that are returned may be decoded to extract the unique data that is associated with each tag. The unique data may then be used to look up and retrieve the information relating to the specific aircraft 100 in a database. When the VDGS 120 is used during automated alignment, the type and sub-type as determined by (or provided to) the VDGS 120 may be confirmed, based upon the retrieved information relating to the specific aircraft 100.

Of course, other systems may also be envisaged which still fall within the scope of an embodiment of the instant invention. For instance, a system including a passive RFID tag, an antenna, a processor and a bridge controller. In particular, the passive RFID tag is for being disposed at a known location aboard an aircraft, relative to a doorway thereof, the passive RFID tag including a tag antenna and an integrated circuit for encoding data relating to the passive RFID tag. Optionally, the encoded data is one of unique to the passive RFID tag, common to a known group of passive RFID tags, or common to all passive RFID tags that are used for alignment of passenger boarding bridges. The antenna is for being disposed proximate the aircraft-engaging end of the passenger boarding bridge, for emitting radio frequency waves and for receiving from the passive RFID tag a wireless data communication signal including the encoded data. Optionally, the antenna is a directional antenna including a plurality of antenna elements, such as for instance at least four rf antenna elements. The processor is in communication with the antenna, and is for identifying the encoded data within the wireless data communication signal, for determining spatial information relating to a location of the passive RFID tag relative to the antenna and for determining an intensity of the signal including the encoded data. When the antenna is a directional antenna, the spatial information may be determined directly based on a determined angle of arrival of the wireless data communication signal. When the antenna is not a directional antenna, then optionally a sensor is used for sensing other information relating to at least one of a location of the doorway of the aircraft relative to the said sensor and a location of a passive RFID tag relative to the said sensor. For instance, the sensor is one of an imager and a second antenna. The bridge controller is in communication with the processor for determining a movement of the passenger boarding bridge toward the doorway of the aircraft based on the determined spatial information and the intensity of the signal including the encoded data. When the sensor is used in conjunction with the passive RFID, then optionally the determination of the movement of the passenger boarding bridge also takes into account the other information relating to the location of the doorway of the aircraft relative to the said sensor.

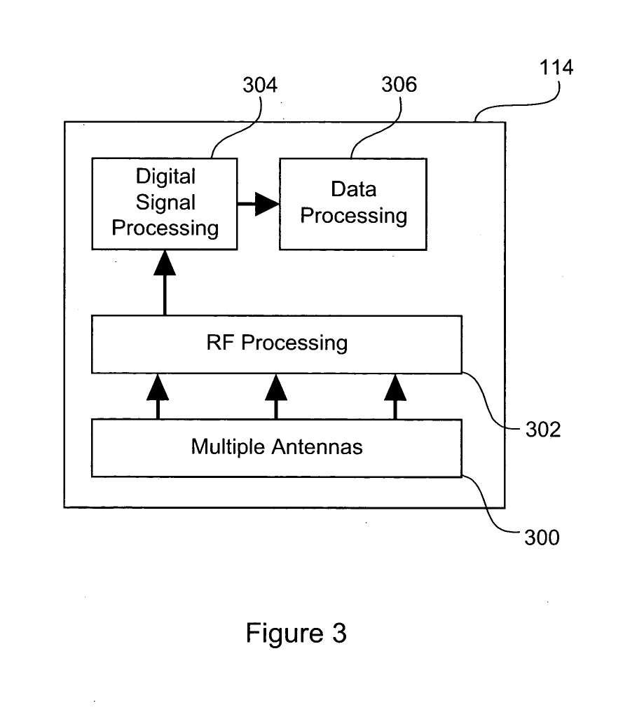

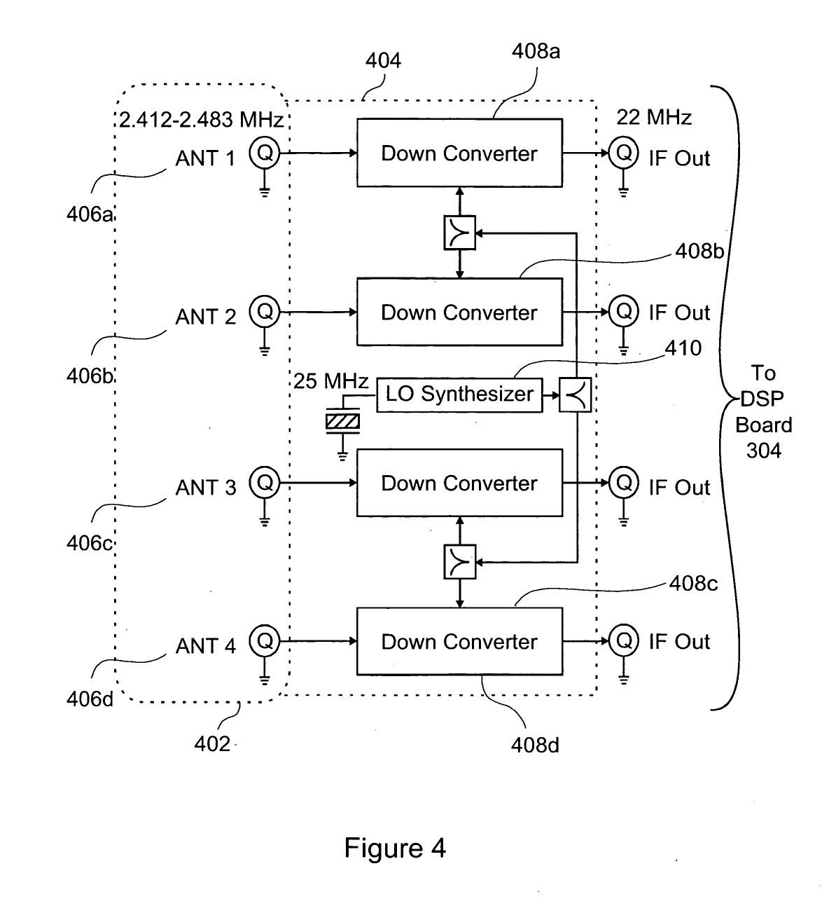

FIG. 3 illustrates by way of a specific and non-limiting example a high level diagram of a directional RFID reader 114. Disposed within directional RFID reader 114 is an array of RF antennas 300, RF processing circuitry 302, digital signal processing (DSP) circuitry 304, and data processing circuitry 306 for communicating with the controller 112 of the automated bridge alignment system. FIG. 4 illustrate the directional RFID reader 114 in more detail.

FIG. 4 illustrates in greater detail the directional RFID reader of FIG. 3. In particular, FIG. 4 illustrates the front-end circuitry RF board, 300 and 302, of the directional RFID reader 114. This circuitry provides a direct conversion subsystem, with zero IF, that converts the 802.11x signals, which are between 2.412-2.483 GHz, to I/Q baseband signals for processing by the DSP 304. The RF board, 302, includes four receiver chains in parallel. RF signals are received by each of the four RF antennas, 406a through 406d. Disposed within each receiver chain, between the RF antenna and an output port thereof, is a corresponding down converter circuit 408a through 408d. Each of the four receiver chains obtain their LO signals from a common LO frequency synthesizer 410 in order to ensure substantially and identical performance for all of the receiver chains. Four output ports provide the IF output signals to the DSP 304.

The directional RFID reader 114 described with reference to FIG. 3 and FIG. 4 is intended to serve as a specific and non-limiting example. Other directional RFID readers may be used instead of the one shown in the specific example, utilizing for instance a number of antenna elements other than four. Further optionally, a plurality of RFID readers may be disposed proximate the aircraft-engaging end 110 of passenger boarding bridge 102. With increasing numbers of directional RFID readers, improved accuracy is expected.

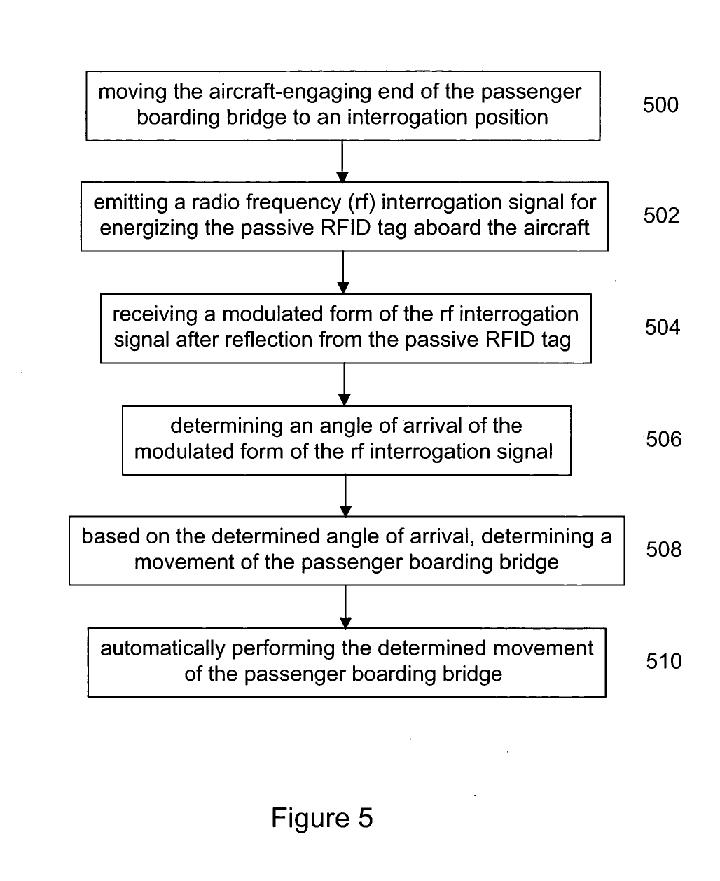

Referring now to FIG. 5, shown is a simplified flow diagram of a method according to an embodiment of the instant invention. The method is for aligning an aircraft-engaging end of a passenger boarding bridge with a doorway of an aircraft, the aircraft equipped with a passive radio frequency identification (RFID) tag that is disposed at a known location relative to the doorway. At step 500 the aircraft-engaging end of the passenger boarding bridge is moved to an interrogation position. In particular, the interrogation position is based on an expected stopping location of the doorway of the aircraft. At step 502, using a plurality of antenna elements disposed aboard the passenger boarding bridge, a radio frequency (rf) interrogation signal is emitted for energizing the passive RFID tag. At step 504, using the plurality of antenna elements disposed aboard the passenger boarding bridge, a modulated form of the rf interrogation signal is received after reflection from the passive RFID tag. At step 506, an angle of arrival of the modulated form of the rf interrogation signal is determined, based on differences in the signal received at each of the plurality of antenna elements. At step 508, based on the determined angle of arrival, a movement of the passenger boarding bridge toward the doorway of the aircraft is determined. At step 510, the determined movement of the passenger boarding bridge toward the doorway of the aircraft is performed automatically.

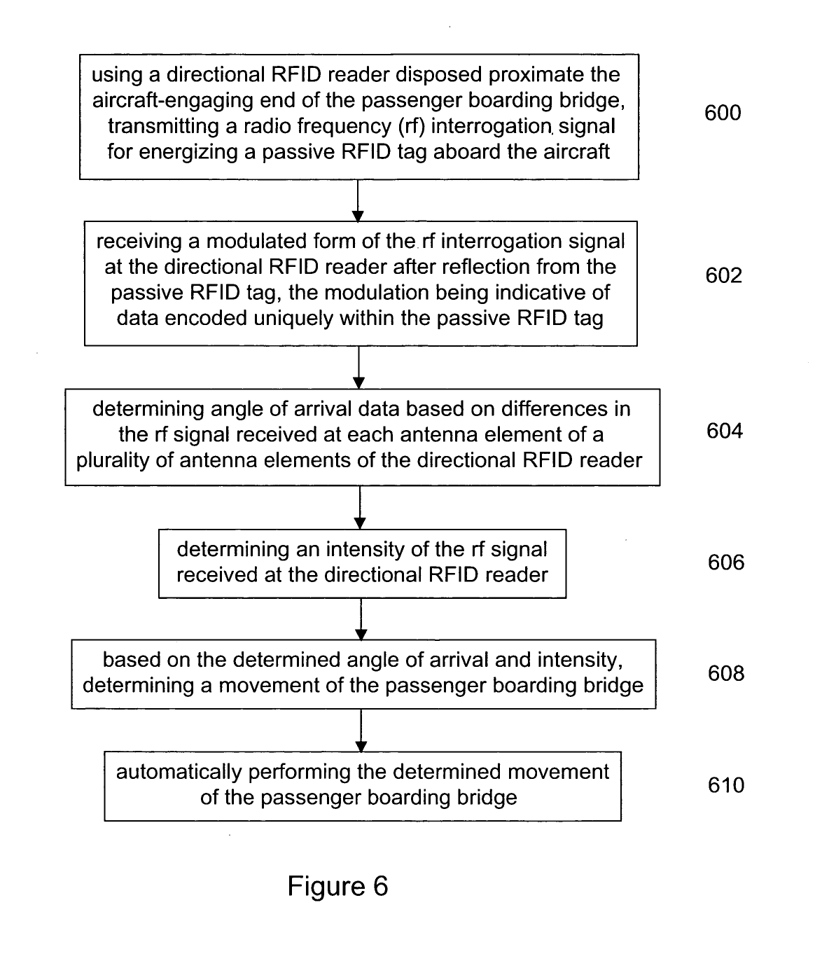

FIG. 6 is a simplified flow diagram of another method according to an embodiment of the instant invention. The method is for aligning an aircraft-engaging end of a passenger boarding bridge with a doorway of an aircraft, the aircraft equipped with a passive radio frequency identification (RFID) tag that is disposed at a known location relative to the doorway. At step 600, using a directional RFID reader that is disposed proximate the aircraft-engaging end of the passenger boarding bridge, a radio frequency (rf) interrogation signal is transmitted for energizing the passive RFID tag. At step 602 an rf signal is received at the directional RFID reader, the rf signal being a modulated form of the rf interrogation signal reflected from the passive RFID tag. In particular, the modulation is indicative of data that is encoded uniquely within the passive RFID tag. At step 604 angle of arrival data is determined based on differences in the rf signal received at each antenna element of a plurality of antenna elements of the directional RFID reader. At step 606 an intensity of the rf signal received at the directional RFID reader is determined. Based on the determined angle of arrival data and the determined intensity, a movement of the passenger boarding bridge is determined at step 608 for moving the aircraft-engaging end thereof toward the doorway of the aircraft. At step 610 the determined movement of the passenger boarding bridge toward the doorway of the aircraft is performed automatically.

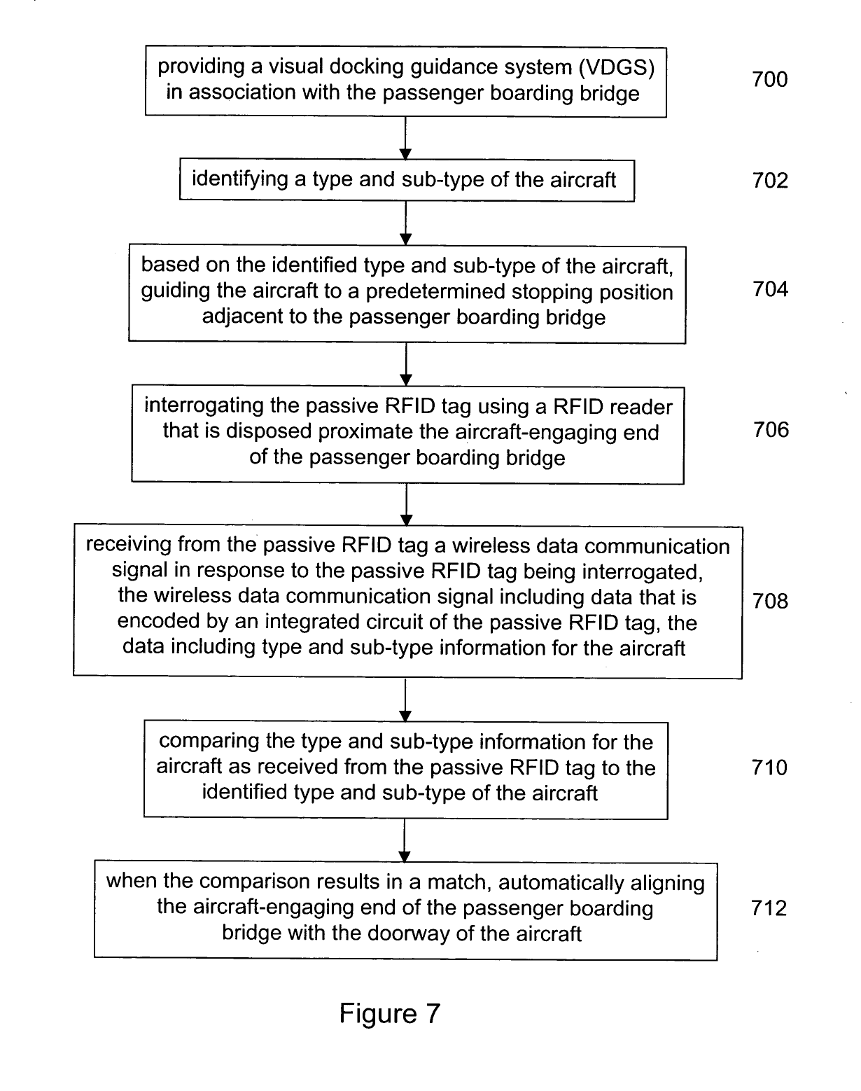

FIG. 7 is a simplified flow diagram of another method according to an embodiment of the instant invention. The method is for aligning an aircraft-engaging end of a passenger boarding bridge with a doorway of an aircraft, the aircraft being equipped with a passive radio frequency identification (RFID) tag. At step 700 a visual docking guidance system (VDGS) is provided in association with the passenger boarding bridge. For instance the VDGS 120 described supra, including a sensing portion for sensing approach of the aircraft toward the stopping position and a display portion for providing instructions in the form of symbols and/or alphanumeric characters, is provided in association with the passenger boarding bridge. At step 702 the type and sub-type of the aircraft is identified. Optionally, the aircraft type and sub-type identification is performed in an automated manner by a processor of the VDGS, based upon sensed characteristics of the aircraft. Optionally, the aircraft type and sub-type identification is based on information that is available via the Flight Information Display System (FIDS) of the airport. Optionally, a human operator performs the aircraft type and sub-type identification via a user interface.

At step 704, based on the identified type and sub-type of the aircraft, the VDGS is used to guide the aircraft to a predetermined stopping position adjacent to the passenger boarding bridge. At step 706 the passive RFID tag is interrogated using a RFID reader that is disposed proximate the aircraft-engaging end of the passenger boarding bridge. For instance the passive RFID tag is interrogated after the aircraft has come to a stop at the predetermined stopping position. At step 708 a wireless data communication signal is received from the passive RFID tag in response to the passive RFID tag being interrogated. For instance, the wireless data communication signal includes data that is encoded by an integrated circuit of the passive RFID tag, the data including type and sub-type information for the aircraft. At step 710 a comparison is made between the type and sub-type information for the aircraft as received from the passive RFID tag and the identified type and sub-type of the aircraft. For instance, controller 112 performs the comparison in an automated manner. At step 712, when it is determined that the comparison results in a match, the aircraft-engaging end of the passenger boarding bridge is aligned automatically with the doorway of the aircraft. For instance, a match is defined as when the type and sub-type information for the aircraft as received from the passive RFID tag is identical to the identified type and sub-type of the aircraft. Optionally, a match is defined as when the type and sub-type information for the aircraft as received from the passive RFID tag and the identified type and sub-type of the aircraft are determined to be within a defined group of aircraft types and sub-types. By way of a specific and non-limiting example, the defined group of aircraft types and sub-types optionally is characterized according to the expected stopping location of the doorway to which the aircraft-engaging end of the passenger boarding bridge is to be aligned, when the aircraft is stopped at the predetermined stopping position for the identified type and sub-type of the aircraft. In other words, automated alignment is possible even when the type and sub-type of the aircraft is identified incorrectly, and the aircraft is guided to an incorrect stopping position for the actual type and sub-type of the aircraft, provided that the doorway of the aircraft is within interrogation range of the RFID reader when the passenger boarding bridge is at an interrogation position. Once the type and sub-type of the aircraft is confirmed based on the type and sub-type information for the aircraft as received from the passive RFID tag, the controller 112 optionally retrieves parameters relating to the actual type and sub-type of the aircraft, for use in aligning the aircraft engaging end of the passenger boarding bridge with the doorway of the aircraft. Alternatively, when it is determined that the comparison does not result in a match, then the alignment operation is aborted, and a human operator is paged to complete the alignment in an automated manner.

Advantageously the passive RFID tags. 116, 200 and 202 are inexpensive and do not rely upon an internal power supply. The tags operate in passive mode only, that is to say they do not provide rf signals unless interrogated by an RFID reader. Accordingly, there is no need to turn the tags on and off if their use is prohibited in certain jurisdictions, since such jurisdictions would not utilize an RFID reader at locations proximate the aircraft. In addition, the tags inherently encode unique data and additional programming of the tags is not required during installation aboard the aircraft or at a later time. Rather, the unique data encoded by the tag merely is associated with information relating to the aircraft aboard which the tag is installed. The lifetime of such passive RFID tags is long and reliable operation is expected during the lifetime. The installation of the passive RFID tags is inexpensive and may be performed without special training. For instance, the passive RFID tag may be affixed to the interior surface of the window of a doorway using double-sided tape or another suitable adhesive.

Numerous other embodiments may be envisaged without departing from the spirit and scope of the invention.

What is claimed is:

1. A system for aligning an aircraft-engaging end of a passenger boarding bridge with a doorway of an aircraft, comprising:
a passive radio frequency identification (RFID) tag for being disposed at a known location aboard the aircraft relative to the doorway, the passive RFID tag comprising a tag antenna and an integrated circuit for encoding data relating to the passive RFID tag;
an antenna for being disposed proximate the aircraft-engaging end of the passenger boarding bridge, for emitting radio frequency waves and for receiving from the passive RFID tag a wireless data communication signal including the encoded data;
a processor for identifying the encoded data within the wireless data communication signal, for determining spatial information relating to a location of the passive RFID tag relative to the antenna and for determining an intensity of the signal including the encoded data; and,
a bridge controller in communication with the processor for determining a movement of the passenger boarding bridge toward the doorway of the aircraft based on the determined spatial information and the intensity of the signal including the encoded data.

2. A system according to claim 1, wherein the antenna comprises a directional antenna.

3. A system according to claim 2, wherein the directional antenna comprises a plurality of antenna elements.

4. A system according to claim 3, wherein the plurality of antenna elements comprises at least four radio frequency (rf) antenna elements.

5. A system according to claim 3, comprising a plurality of transceiver elements, each transceiver element of the plurality of transceiver elements in communication with the processor and with one antenna element of the plurality of antenna elements, for controlling exchange of data therebetween.

6. A system according to claim 1, further comprising a sensor for sensing other information relating to a location of the doorway of the aircraft relative to the said sensor.

7. A system according to claim 6, wherein the said sensor comprises an imager for capturing image data relating to the location of the doorway of the aircraft.

8. A system according to claim 6, wherein the said sensor comprises a second antenna for emitting radio frequency waves and for receiving from the passive RFID tag a wireless data communication signal including the encoded data.

9. A system according to claim 8, wherein the second antenna comprises a directional antenna.

10. A system according to claim 1, wherein the data encoded by the integrated circuit is data that is unique to the passive RFID tag.

11. A system according to claim 1, wherein the passive RFID tag uses an 802.xx compatible data transmission protocol for providing the wireless data communication signal including the encoded data.

12. A system according to claim 1, comprising a drive mechanism in communication with the bridge controller for receiving therefrom a control signal relating to the determined movement of the passenger boarding bridge, and for actuating the determined movement in accordance with the control signal.

13. A system for aligning an aircraft-engaging end of a passenger boarding bridge with a doorway of an aircraft, comprising:
a first passive radio frequency identification (RFID) tag for being disposed at a known first location aboard the aircraft relative to the doorway, the first passive RFID tag comprising a first tag antenna and a first integrated circuit for encoding first data that is unique to the first passive RFID tag;
a first directional RFID reader for being disposed proximate the aircraft-engaging end of the passenger boarding bridge, the first directional RFID reader comprising a plurality of first radio frequency (rf) antenna elements for conductively coupling with the first tag antenna so as to support exchange of first wireless communication signals therebetween, and a first processor for determining first directional information relating to the first passive RFID tag based on the exchanged first wireless communication signals; and,
a bridge controller in communication with the first directional RFID reader for determining a movement of the passenger boarding bridge toward the doorway of the aircraft based on the determined first directional information.

14. A system according to claim 13, wherein the first passive RFID tag and the first directional RFID reader use an 802.xx compatible data transmission protocol for exchanging the first wireless data communication signals therebetween.

15. A system according to claim 13, wherein the plurality of first rf antenna elements comprises at least four rf antenna elements.

16. A system according to claim 13, comprising a drive mechanism in communication with the bridge controller for receiving therefrom a control signal relating to the determined movement of the passenger boarding bridge, and for actuating the determined movement in accordance with the control signal.

17. A system according to claim 13, comprising a second passive RFID tag for being disposed at a known second location aboard the aircraft relative to at least one of the first passive RFID tag and the doorway.

18. A system according to claim 17, wherein the second passive RFID tag comprises a second tag antenna and a second integrated circuit for encoding second data that is unique to the second passive RFID tag.

19. A system according to claim 13, comprising a second directional RFID reader for being disposed proximate the aircraft-engaging end of the passenger boarding bridge and spatially separated from the first directional RFID reader.

20. A system according to claim 19, wherein the second directional RFID reader comprises a plurality of second rf antenna elements for conductively coupling with the first tag antenna so as to support exchange of second wireless communication signals therebetween, and a second processor for determining second directional information relating to the first passive RFID tag based on the exchanged second wireless communication signals.

21. A system according to claim 20, wherein the plurality of second rf antenna elements comprises at least four rf antenna elements.

22. A method for aligning an aircraft-engaging end of a passenger boarding bridge with a doorway of an aircraft, the aircraft equipped with a passive radio frequency identification (RFID) tag that is disposed at a known location relative to the doorway, the method comprising:
moving the aircraft-engaging end of the passenger boarding bridge to an interrogation position, the interrogation position based on an expected stopping location of the doorway of the aircraft;
using a plurality of antenna elements disposed aboard the passenger boarding bridge, emitting a radio frequency (rf) interrogation signal for energizing the passive RFID tag;
using the plurality of antenna elements disposed aboard the passenger boarding bridge, receiving a modulated form of the rf interrogation signal after reflection from the passive RFID tag;
determining an angle of arrival of the modulated form of the rf interrogation signal based on differences in the signal received at each of the plurality of antenna elements;
based on the determined angle of arrival, determining a movement of the passenger boarding bridge toward the doorway of the aircraft; and,
automatically performing the determined movement of the passenger boarding bridge toward the doorway of the aircraft.

23. A method according to claim 22, comprising determining distance information between the aircraft-engaging end of the passenger boarding bridge and the passive RFID tag, wherein the determined distance information is used in the determination of the movement of the passenger boarding bridge toward the doorway of the aircraft.

24. A method according to claim 23, wherein the determined distance information is based upon an intensity of the modulated form of the rf interrogation signal that is received at each one of the plurality of antenna elements.

25. A method according to claim 22, comprising decoding the modulated form of the rf interrogation signal to extract therefrom unique identification data of the passive RFID tag.

26. A method according to claim 22, comprising prior to moving the aircraft-engaging end of the passenger boarding bridge to the interrogation position, identifying a type and sub-type of the aircraft, wherein the interrogation position is a predetermined position for the determined type and sub-type of the aircraft.

27. A method according to claim 26, comprising prior to automatically performing the determined movement of the passenger boarding bridge toward the doorway of the aircraft, decoding the modulated form of the rf interrogation signal to extract therefrom unique identification data of the passive RFID tag.

28. A method according to claim 27, comprising retrieving from an information database, information relating to a specific aircraft that is associated with the unique identification data of the passive RFID tag.

29. A method according to claim 28, wherein the information relating to the specific aircraft includes at least type and sub-type information for the specific aircraft.

30. A method according to claim 29, comprising comparing the type and sub-type information for the specific aircraft to the identified type and sub-type of the aircraft, so as to confirm correct identification of the type and sub-type of the aircraft.

31. A method according to claim 30, comprising aborting the alignment of the aircraft-engaging end of the passenger boarding bridge with the doorway of the aircraft when the step of comparing does not result in confirmation of correct identification of the type and sub-type of the aircraft.

32. A method according to claim 22, wherein moving the aircraft-engaging end of the passenger boarding bridge to an interrogation position is performed under the control of an automated alignment system of the passenger boarding bridge.

33. A method for aligning an aircraft-engaging end of a passenger boarding bridge with a doorway of an aircraft, the aircraft equipped with a passive radio frequency identification (RFID) tag that is disposed at a known location relative to the doorway, the method comprising:
using a directional RFID reader that is disposed proximate the aircraft-engaging end of the passenger boarding bridge, transmitting a radio frequency (rf) interrogation signal for energizing the passive RFID tag;
receiving an rf signal at the directional RFID reader, the rf signal being a modulated form of the rf interrogation signal reflected from the passive RFID tag, wherein the modulation is indicative of data that is encoded uniquely within the passive RFID tag;
determining angle of arrival data based on differences in the rf signal received at each antenna element of a plurality of antenna elements of the directional RFID reader;
determining an intensity of the rf signal received at the directional RFID reader;
based on the determined angle of arrival data and the determined intensity, determining a movement of the passenger boarding bridge for moving the aircraft-engaging end thereof toward the doorway of the aircraft; and,
automatically performing the determined movement of the passenger boarding bridge toward the doorway of the aircraft.

34. A system for aligning an aircraft-engaging end of a passenger boarding bridge with a doorway of an aircraft, comprising:
a passive radio frequency identification (RFID) tag for being disposed at a known location aboard the aircraft relative to the doorway, the passive RFID tag comprising a tag antenna and an integrated circuit for encoding data that is unique to the passive RFID tag;
a plurality of antenna elements for being disposed proximate the aircraft-engaging end of the passenger boarding bridge, for emitting radio frequency waves and for receiving from the passive RFID tag a wireless data communication signal including the encoded data;
a processor for identifying the encoded data within the wireless data communication signal, for determining an angle of arrival of the encoded data based on differences in signal received at each of the plurality of antenna elements and for determining an intensity of the signal including the encoded data; and,
a bridge controller in communication with the processor for determining a movement of the passenger boarding bridge toward the doorway of the aircraft based on the determined angle of arrival of the encoded data and the intensity of the signal including the encoded data.

35. A system according to claim 34, wherein the passive RFID tag uses an 802.xx compatible data transmission protocol for providing the wireless data communication signal including the encoded data.

36. A system according to claim 34, wherein the plurality of antenna elements comprises at least four radio frequency (rf) antennas.

37. A system according to claim 34, comprising a plurality of transceiver elements, each transceiver element of the plurality of transceiver elements in communication with the processor and with one antenna element of the plurality of antenna elements, for controlling exchange of data therebetween.

38. A system according to claim 34, comprising a drive mechanism in communication with the bridge controller for receiving therefrom a control signal relating to the determined movement of the passenger boarding bridge, and for actuating the determined movement in accordance with the control signal.

39. A method for aligning an aircraft-engaging end of a passenger boarding bridge with a doorway of an aircraft, the aircraft equipped with a passive radio frequency identification (RFID) tag, the method comprising:
providing a visual docking guidance system (VDGS) in association with the passenger boarding bridge;
identifying a type and sub-type of the aircraft;
based on the identified type and sub-type of the aircraft, guiding the aircraft to a predetermined stopping position adjacent to the passenger boarding bridge;
interrogating the passive RFID tag using a RFID reader that is disposed proximate the aircraft-engaging end of the passenger boarding bridge;
receiving from the passive RFID tag a wireless data communication signal in response to the passive RFID tag being interrogated, the wireless data communication signal including data that is encoded by an integrated circuit of the passive RFID tag, the data including type and sub-type information for the aircraft;
comparing the type and sub-type information for the aircraft as received from the passive RFID tag to the identified type and sub-type of the aircraft; and,
when the comparison results in a match, automatically aligning the aircraft-engaging end of the passenger boarding bridge with the doorway of the aircraft.

39. A method according to claim 38, wherein the step of identifying the type and sub-type of the aircraft is performed in an automated manner by a processor of the VDGS, based upon sensed characteristics of the aircraft.

40. A method according to claim 38, wherein the step of identifying the type and sub-type of the aircraft comprises providing type and sub-type data to the VDGS for use thereby in guiding the aircraft to the predetermined stopping position adjacent to the passenger boarding bridge.

41. A method according to claim 38, wherein a match results when the type and sub-type information for the aircraft as received from the passive RFID tag is identical to the identified type and sub-type of the aircraft.

42. A method according to claim 38, wherein a match results when the type and sub-type information for the aircraft as received from the passive RFID tag and the identified type and sub-type of the aircraft are determined to be within a defined group of aircraft types and sub-types.

43. A method according to claim 42, wherein the defined group of aircraft types and sub-types is characterized according to the expected stopping location of the doorway to which the aircraft-engaging end of the passenger boarding bridge is to be aligned, when the aircraft is stopped at the predetermined stopping position for the identified type and sub-type of the aircraft.

44. A method according to claim 38, comprising aborting the alignment of the aircraft-engaging end of the passenger boarding bridge with the doorway of the aircraft when the comparison does not result in a match.

45. A method according to claim 38, wherein the RFID reader is a directional RFID reader, and wherein automatically aligning the aircraft-engaging end of the passenger boarding bridge with the doorway of the aircraft comprises determining the direction and distance to the passive RFID tag relative to the directional RFID reader.

46. A method according to claim 45, wherein automatically aligning the aircraft-engaging end of the passenger boarding bridge with the doorway of the aircraft comprises determining a movement of the passenger boarding bridge toward the doorway of the aircraft based on the determined direction and distance to the passive RFID tag, and based on a known location of the passive RFID tag relative to the doorway.
